(19) United States
(12) Patent Application Publication
(10) Pub. No.: US 2025/0080976 A1
(43) Pub. Date: Mar. 6, 2025

(54) METHOD FOR PROTECTING MESSAGE AND APPARATUS IMPLEMENTING THE SAME

(71) Applicant: SAMSUNG SDS CO., LTD., Seoul (KR)

(72) Inventors: Dae Yeoul LEE, Seoul (KR); Seung Min YEO, Seoul (KR); Do Yeon KOO, Seoul (KR)

(73) Assignee: SAMSUNG SDS CO., LTD., Seoul (KR)

(21) Appl. No.: 18/745,405

(22) Filed: Jun. 17, 2024

(30) Foreign Application Priority Data
Sep. 4, 2023 (KR) 10-2023-0116710

(51) Int. Cl. H04W 12/02; H04W 4/12

(52) U.S. Cl. CPC H04W 12/02; H04W 4/12

(57) ABSTRACT

There is provided a method for protecting a message, performed by a transmitting terminal. The method may comprise acquiring a protection message; configuring message data for transmission by excluding at least a portion of a text of the protection message; transmitting the message data to a receiving terminal of the protection message; receiving a text request for the protection message from the receiving terminal; and transmitting the text of the protection message to the receiving terminal in response to the text request.

### CROSS-REFERENCE TO RELATED APPLICATION

This application claims priority from Korean Patent Application No 10-2023-0116710 filed on Sep. 4, 2023, in the Korean Intellectual Property Office and all the benefits accruing therefrom under 35 U.S.C. 119, the contents of which in its entirety are herein incorporated by reference.

### BACKGROUND

### Technical Field

The present disclosure relates to a method for protecting a message and an apparatus (e.g., server or user terminal) implementing the same.

### Description of the Related Art

With the rapid development of information and communication technology and the popularization of message services, an environment in which messages can be exchanged between users regardless of time and place has been constructed. For example, a user may send a message to another user at a remote location at any time through a message client (e.g., messenger app) installed on his or her terminal.

However, when a user of a message service checks a message received in a public place such as a subway or a bus, a problem may occur in that sensitive information of a message sender or recipient is exposed to others. In addition, there are many users who use a message service for easy communication but are reluctant to store their sensitive information in a message server.

### BRIEF SUMMARY

An object of the present disclosure is to provide a method for effectively protecting information contained in a message and an apparatus (e.g., user terminal or server) implementing the same.

The objects of the present disclosure are not limited to those mentioned above and additional objects of the present disclosure, which are not mentioned herein, will be clearly understood by those skilled in the art from the following description of the present disclosure.

According to an aspect of the present closure, there is provided a method for protecting a message, performed by a transmitting terminal. The method may comprise acquiring a protection message; configuring message data for transmission by excluding at least a portion of a text of the protection message; transmitting the message data to a receiving terminal of the protection message; receiving a text request for the protection message from the receiving terminal; and transmitting the text of the protection message to the receiving terminal in response to the text request.

In some embodiments, the protection message may be a message in which a protection function is set by a user of the transmitting terminal.

In some embodiments, the configuring message data may include configuring the message data only with metadata except for the text of the protection message.

In some embodiments, policy setting information on the protection message may include setting information on a minimum text exposed to a user of the receiving terminal, and the configuring message data may include configuring the message data to include a portion of the text of the protection message, which is set as a minimum text.

In some embodiments, the method may further comprise receiving a switching request for the protection message from a user of the transmitting terminal—the switching request being a request to switch the protection message to a general message—; and transmitting a protection function release request including the text of the protection message to the receiving terminal in response to the switching request, wherein the receiving terminal receiving the protection function release request processes the text to be exposed to a user of the receiving terminal.

In some embodiments, the method may further comprise receiving a switching request for the protection message from the receiving terminal—the switching request being a request to switch the protection message to a general message—; receiving a user input for approving the switching request from a user of the transmitting terminal; and transmitting an approval notification including the text of the protection message to the receiving terminal in response to the user input, wherein the receiving terminal receiving the approval notification processes the text to be exposed to a user of the receiving terminal.

In some embodiments, the method may further comprise transmitting a message to the receiving terminal—the message being a general message in which a text is exposed to a user of the receiving terminal—; receiving a switching request for the message from a user of the transmitting terminal—the switching request being a request to switch the message to the protection message—; and transmitting a protection function setting request for the message to the receiving terminal in response to the switching request, wherein the receiving terminal receiving the protection function setting request processes at least a portion of the text of the message to be non-exposed.

In some embodiments, the method may further comprise transmitting a message to the receiving terminal—the message being a general message in which a text is exposed to a user of the receiving terminal—; receiving a switching request for the message from the receiving terminal—the switching request being a request to switch the message to the protection message—; receiving a user input for approving the switching request from a user of the transmitting terminal; and transmitting an approval notification for the switching request to the receiving terminal in response to the user input, wherein the receiving terminal receiving the approval notification processes at least a portion of the text of the message to be non-exposed.

According to another aspect of the present closure, there is provided a method for protecting a message, performed by a message server. The method may comprise receiving message data for a protection message from a transmitting terminal—the message data for not including at least a portion of a text of the protection message—; transmitting the message data to a receiving terminal of the protection message; receiving a text request for the protection message from the receiving terminal and forwarding the text request to the transmitting terminal; and receiving the text of the protection message from the transmitting terminal and forwarding the text to the receiving terminal.

In some embodiments, the text of the protection message may be temporarily stored in a storage of the message server and may be deleted from the storage as a temporary storage period set in the protection message elapses.

In some embodiments, the method may further comprise re-receiving the text request for the protection message from the receiving terminal; when there is a text temporarily stored in the storage. transmitting the temporarily stored text to the receiving terminal; and re-acquiring the text of the protection message through the transmitting terminal and transmitting the text to the receiving terminal when there is no text temporarily stored in the storage.

In some embodiments, the method may further comprise temporarily storing the text of the protection message in a storage; and deleting the temporarily stored text regardless of a temporary storage period set in the protection message when receiving a reading notification for the text of the protection message from the receiving terminal.

In some embodiments, the message data may further be transmitted to another receiving terminal other than the receiving terminal, the forwarding the text request may include forwarding the text to only the receiving terminal when the text request for the protection message is not received from another receiving terminal.

According to still another aspect of the present closure, there is provided a method for protecting a message, performed by a receiving terminal. The method may comprise receiving message data for a protection message from a transmitting terminal—the message data for not including at least a portion of a text of the protection message—; receiving a user input for requesting the text of the protection message from a user of the receiving terminal; transmitting a text request for the protection message to the transmitting terminal in response to the user input; and receiving the text of the protection message from the transmitting terminal and processing the received text to be exposed to the user.

In some embodiments, the received text may be processed to be non-exposed as a preset time elapses.

According to still another aspect of the present closure, there is provided a transmitting terminal. The transmitting terminal may comprise one or more processors; a communication interface; and a memory storing a computer program executed by one or more processors, wherein the computer program includes instructions to perform: an operation of acquiring a protection message; an operation of configuring message data for transmission by excluding at least a portion of a text of the protection message; an operation of transmitting the message data to a receiving terminal of the protection message; an operation of receiving a text request for the protection message from the receiving terminal; and an operation of transmitting the text of the protection message to the receiving terminal in response to the text request.

In some embodiments, the transmitting terminal may further comprise instructions to perform: an operation of receiving a switching request for the protection message from a user of the transmitting terminal—the switching request being a request to switch the protection message to a general message—; and an operation of transmitting a protection function release request including the text of the protection message to the receiving terminal in response to the switching request, wherein the receiving terminal receiving the protection function release request processes the text to be exposed to a user of the receiving terminal.

In some embodiments, the transmitting terminal may further comprise instructions to perform: an operation of receiving a switching request for the protection message from the receiving terminal—the switching request being a request to switch the protection message to a general message—; an operation of receiving a user input for approving the switching request from a user of the transmitting terminal; and an operation of transmitting an approval notification including the text of the protection message to the receiving terminal in response to the user input, wherein the receiving terminal receiving the approval notification processes the text to be exposed to a user of the receiving terminal.

In some embodiments, the transmitting terminal may further comprise instructions to perform: an operation of transmitting a message to the receiving terminal—the message being a general message in which a text is exposed to a user of the receiving terminal—; an operation of receiving a switching request for the message from a user of the transmitting terminal—the switching request being a request to switch the message to the protection message—; and an operation of transmitting a protection function setting request for the message to the receiving terminal in response to the switching request, wherein the receiving terminal receiving the protection function setting request processes at least a portion of the text of the message to be non-exposed.

In some embodiments, the transmitting terminal may further comprise instructions to perform: an operation of transmitting a message to the receiving terminal—the message being a general message in which a text is exposed to a user of the receiving terminal—; an operation of receiving a switching request for the message from the receiving terminal—the switching request being a request to switch the message to the protection message—; an operation of receiving a user input for approving the switching request from a user of the transmitting terminal; and an operation of transmitting an approval notification for the switching request to the receiving terminal in response to the user input, wherein the receiving terminal receiving the approval notification processes at least a portion of the text of the message to be non-exposed.

According to some embodiments of the present disclosure, message data for transmitting a protection message may be configured by excluding at least a portion of a text of the corresponding protection message. Accordingly, a case that an entire text of the protection message is exposed from a receiving terminal may be avoided in advance. For example, a case that sensitive information of a sender and/or a recipient is exposed to others in a public place may be avoided in advance.

Also, only when the recipient requests a text, the text of the protection message may be transmitted from a transmitting terminal to a receiving terminal and exposed to the recipient. Accordingly, a case that sensitive information of the sender and/or the recipient is exposed due to the carelessness of the recipient or the like may be minimized.

Also, the text of the protection message is temporarily stored in a storage of a message server, and may be deleted from the storage as a predetermined temporary storage period elapses. Accordingly, a message protection function may be further enhanced.

Also, as a predetermined exposure time elapses based on a time point at which the text of the protection message is exposed to the receiving terminal, a non-exposure processing may be automatically performed for the corresponding text. Accordingly, the message protection function may be further enhanced.

Also, as protection processing is performed for a message in accordance with a configurable protection policy, a flexible message protection function may be provided.

Also, as a switching function between a general message and a protection message is provided in accordance with a request of the sender or the recipient, a flexible message protection function may be implemented.

The effects according to the embodiment of the present disclosure are not limited to those mentioned above, and more various effects are included in the following description of the present disclosure.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is an exemplary view illustrating an environment in which a method for protecting a message according to some embodiments of the present disclosure is performed and apparatuses implementing the same;

FIG. 2 is an exemplary flow chart illustrating a general process of a method for protecting a message according to some embodiments of the present disclosure;

FIG. 3 is an exemplary view illustrating a general process of a method for protecting a message according to some embodiments of the present disclosure;

FIG. 4 is an exemplary view illustrating a text transmission method when there are a plurality of receiving terminals in accordance with some embodiments of the present disclosure;

FIG. 5 is an exemplary flow chart illustrating a process of switching a general message to a protection message in accordance with some embodiments of the present disclosure;

FIG. 6 is an exemplary view for additionally describing the process of switching to the protection message, which is shown in FIG. 5;

FIG. 7 is an exemplary flow chart illustrating a process of switching a general message to a protection message in accordance with some other embodiments of the present disclosure;

FIG. 8 is an exemplary flow chart illustrating a process of switching a protection message to a general message in accordance with some embodiments of the present disclosure;

FIG. 9 is an exemplary view for additionally describing the process of switching to the general message, which is shown in FIG. 8;

FIG. 10 is an exemplary flow chart illustrating a process of switching a protection message to a general message in accordance with some other embodiments of the present disclosure; and

FIG. 11 illustrates an exemplary computing apparatus capable of implementing a transmitting terminal, a receiving terminal and/or a message server in accordance with some embodiments of the present disclosure.

### DETAILED DESCRIPTION OF THE DISCLOSURE

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Hereinafter, embodiments of the present disclosure will be described with reference to the attached drawings.

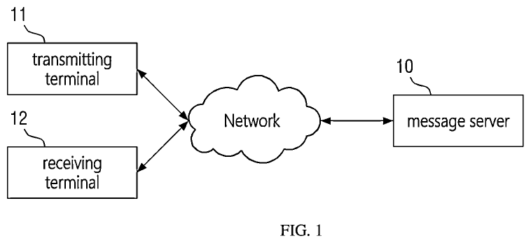

FIG. 1 is an exemplary view schematically illustrating an environment in which a method for protecting a message according to some embodiments of the present disclosure is performed and apparatuses implementing the same.

As shown in FIG. 1, the method for protecting a message according to embodiments may be performed in an environment in which a transmitting terminal 11, a receiving terminal 12 and a message server 10 operate. Although FIG. 1 shows that one transmitting terminal 11 and one receiving terminal 12 perform message communication, the transmitting terminal 11 and the receiving terminal 12 may collectively refer to at least one terminal that performs message communication.

The transmitting terminal 11 means a terminal used by a message sender. For example, a message client (e.g., a messenger app or a web browser) that interworks with the message server 10 may be installed in the transmitting terminal 11, and the sender (i.e., user of the transmitting terminal 11) may transmit a desired message to various recipients through the message client.

The transmitting terminal 11 (e.g., message client) may support a message protection function that may prevent a text (e.g., text including sensitive information such as resident number) of a message from being exposed to the outside. For example, the transmitting terminal 11 first transmits only metadata (or metadata and minimum text) of a message in which a protection function is set, and then transmits a text (content) of the corresponding message, so that the text of the corresponding message may be effectively prevented from being exposed to the outside. Operations of the transmitting terminal 11 will be described in detail with reference to the drawings below.

In the following description, the message in which the protection function is set may be referred to as a ‘protection message’, and a message in which the protection function is not set may be referred to as a ‘general message’.

In some cases, the transmitting terminal 11 may be named as a ‘client terminal’, a ‘message client terminal’, a ‘client’, a ‘message client’, a ‘sender terminal’, a ‘user terminal’, etc.

Next, the receiving terminal 12 refers to a terminal used by a message recipient. For example, a message client interworking with the message server 10 may be installed in the receiving terminal 12, and the recipient (i.e., user of the receiving terminal 12) may check the message received therein through the message client.

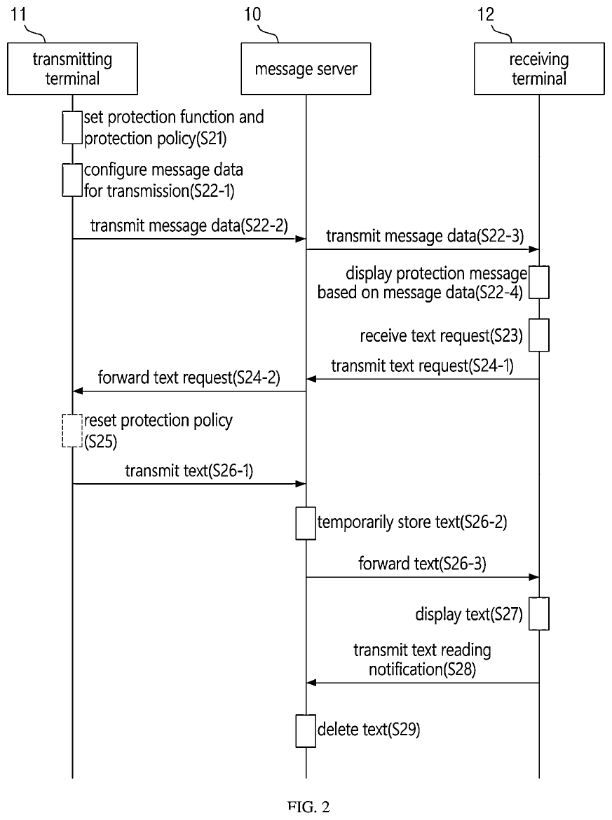

The receiving terminal 12 may also support a message protection function. For example, the receiving terminal 12 may perform non-exposure processing (i.e., message protection processing) to prevent the text of the protection message from being exposed to the outside, and operations of the receiving terminal 12 will be also described in detail with reference to the drawings subsequent to FIG. 2.

In some cases, the receiving terminal 12 may be referred to as a ‘client terminal’, a ‘message client terminal’, a ‘client’, a ‘message client’, a ‘receiving terminal’ or a ‘user terminal’.

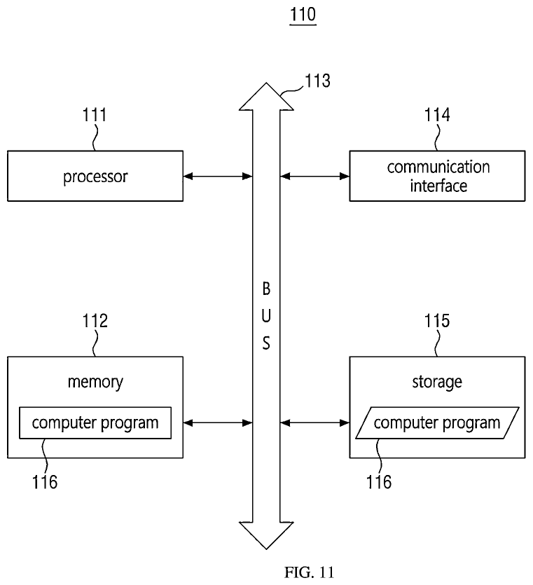

The transmitting terminal 11 and the receiving terminal 12 may be implemented as mobile computing devices (e.g., smartphones), or may be implemented as fixed computing devices (e.g., desktops). An example of the computing device will be described with reference to FIG. 11.

Next, the message server 10 is a computing device/system that provides a message service. The message server 10 may provide various functions (e.g., login, chat room generation, message storage, etc.) for the message service.

The message server 10 may also support the message protection function. For example, the message server 10 may temporarily store the text of the protection message in a storage and delete the corresponding text as a predetermined temporary storage period elapses. As a result, the message protection function may be further enhanced. Operations of the message server 10 will be described in detail with reference to the drawings subsequent to FIG. 2.

The above-described message server 10 may be implemented as at least one computing device. For example, all functions of the message server 10 may be implemented in a single computing device, a first function of the message server 10 may be implemented in a first computing device, and a second function may be implemented in a second computing device. Alternatively, a specific function of the message server 10 may be implemented in a plurality of computing devices.

The computing device may include any device having a computing function, and an example of such a device will be described with reference to FIG. 11. Since a computing device is an assembly in which various components (e.g., memory, processor, etc.) interact, it may be sometimes referred to as a ‘computing system’. Of course, the term ‘computing system’ may also encompass the concept of an assembly in which a plurality of computing devices interact.

As shown, the message server 10 and the terminals 11 and 12 may perform communication with each other through a network. In this case, the network may be implemented as all kinds of wired/wireless networks such as a local area network (LAN), a wide area network (WAN), a mobile radio communication network and a wireless broadband Internet (Wibro).

The environment in which the method for protecting a message, which will be described later, is performed and the apparatuses implementing the same have been schematically described with reference to FIG. 1. Hereinafter, the method for protecting a message according to some embodiments of the present disclosure will be described in detail with reference to the drawings subsequent to FIG. 2.

FIG. 2 is an exemplary flow chart illustrating a general process of a method for protecting a message according to some embodiments of the present disclosure. However, this is only a preferred embodiment for achieving the object of the present disclosure, and some steps may be added or deleted as needed.

As shown in FIG. 2, the present process may start in step S21 of setting, by the transmitting terminal 11, a protection function and a protection policy in a message (i.e., a transmitting message). For example, the transmitting terminal 11 may provide a user interface capable of setting a protection function and/or a protection policy, and a sender may set a protection function and/or a protection policy through the corresponding user interface, but the scope of the present disclosure is not limited thereto. In some cases, the transmitting terminal 11 may set a protection function in the corresponding message in response to receiving a user input (e.g., a mobile gesture such as a double tap) predefined in the message. As the protection function is set, the corresponding message may be changed to (designated as) the protection message (i.e., the type of the message is changed to the protection message). Also, as the protection function is set, the corresponding message may be protected (non-exposed) even in the transmitting terminal 11.

The protection policy is a policy applied to the protection function, and may include various items (i.e., configurable items). Examples of such items may include a temporary storage period, a minimum text (i.e., hint), a text exposure time and the like, but the scope of the present disclosure is not limited thereto. The exemplified items will be given with reference to Table 1 below. Setting information on the protection policy may be included in the metadata of the protection message.

The protection policy may be set for each message or may be set for each chat room, message client, terminal and/or user account. In addition, the protection policy may be set by the sender, and in some cases, may be set by the recipient or a manager of the message server. However, in the following description, in order to provide convenience of understanding, it is assumed that most of the settings of the protection function and the protection policy are performed by the ‘sender’.

Before description of the following steps (e.g., S22-1), the text and metadata of the message will be described first to provide convenience for understanding.

The general message data (or message) may consist of, for example, a text and metadata.

The text means the content of the message. The text may consist of only the text or may further include other types of data (e.g., image, etc.). Alternatively, the text may consist of only data of a format different from the text. However, in the following description, for convenience of understanding, it is assumed that the text consists of only ‘text’.

In some cases, the text may be named as ‘content’, ‘body’, ‘original text’, ‘original’, etc.

Next, the metadata is data that does not correspond to the text, and refers to data necessary for management or processing of the message. The metadata may be composed of various items (fields), and may include, for example, the setting information on the protection policy. Detailed examples of items constituting the metadata will be given with reference to Table 1 below.

TABLE 1

| Classification | Items | Description or examples |
|---|---|---|
| Basis | Chat room ID | Identifier of chat room to which sender |
| | | belongs |
| | Message ID | Identifier of message |
| | Sender information | Identifier (e.g., account) of sender, etc. |
| | Sending time | Timestamp of sending time |
| | Type of text | Text, image, multimedia, etc. |
| | Recipient information | Identifier of recipient, etc. |
| Protection | Whether to use | Whether to apply protection policy set during |
| function/policy | protection policy | message processing |
| | Message type | Protection message, general message, etc. |
| | Text requesting terminal | Information such as identifier of text |
| | | requesting terminal |
| | Temporary storage | Maximum period of time for storage in |
| | period | message server |
| | | NONE: No temporary storage in server |
| | | 1: Temporary storage for 1 hour |
| | | 3: Temporary storage for 3 hours |
| | | 6: Temporary storage for 6 hours |
| | | 24: Temporary storage for 24 hours |
| | | And so on |
| | Minimum text | Minimum text exposed (i.e., provided as a |
| | | hint) to recipient |
| | | NONE: No text provided at all |
| | | 5:5 letters |
| | | 10:10 letters |
| | | 15:15 letters |
| | | and so on (e.g., text in specific part, 1 auto- |
| | | extracted keyword, etc.) |
| | Protection processing | Non-exposure processing method of |
| | method | protection message |
| | | Mark text as blank |
| | | Mark text as dummy (alternative) text |
| | | Marked as dummy text by length of text |
| | | And so on |
| | Whether to open | Whether recipient has opened protection |
| | message (whether to | message (i.e. whether recipient has requested |
| | request text) | text) |
| | | True: Message is opened (however, it may |
| | | be changed to ‘False’ after a certain period of |
| | | time after message is opened (see text |
| | | exposure time item below)) |
| | | False: Message is not opened |
| | Text exposure time | Maximum time of text exposed based on |
| | | time when protection message is opened |
| | | 9999: Keep text exposed |
| | | 9998: Keep text exposed until chat room is |
| | | opened and then processed as non-exposure |
| | | when chat room is closed. |
| | | 10: Exposed for 10 seconds |
| | | 30: Exposed for 30 seconds |
| | | 60: Exposed for 60 seconds |
| | | 600: Exposed for 10 minutes |
| | | And so on |

In some cases, the metadata may be named as ‘header’, ‘management information/data’, etc.

The description will be given with reference to FIG. 2 again.

In step S22-1, the transmitting terminal 11 may configure message data for transmission based on the metadata (e.g., protection policy setting information) of the protection message.

For example, the transmitting terminal 11 may configure the message data only with the metadata except for the text. For example, when a minimum text item of the protection policy is set to ‘NONE’, the transmitting terminal 11 may configure the message data for transmitting the protection message only with the metadata.

As another example, the transmitting terminal 11 may configure the message data based on the minimum text and the metadata. For example, when the minimum text item of the protection policy is set to a value other than ‘NONE’, the transmitting terminal 11 may configure the message data for transmitting the protection message by using the minimum text (i.e., portion set to minimum text in the text of the protection message) set to the corresponding item and the metadata.

When the transmitted message is not the protection message (that is, when the transmitted message is a general message), the transmitting terminal 11 may configure the message data to include the entire text. That is, the transmitting terminal 11 may configure the message data in different ways based on the type of the transmitted message.

In step S22-2, the transmitting terminal 11 may transmit the message data to the message server 10 (that is, the transmitting terminal 11 transmits the message data to the receiving terminal 12 through the message server 10). As a result, the protection message may be transmitted.

In step S22-3, the message server 10 may transmit (forward) the message data to the receiving terminal 12. The message server 10 may forward the message data to the receiving terminal 12 as it is, or may partially extract a portion of the message data and forward the extracted message data to the receiving terminal 12.

In addition, the message server 10 may temporarily keep (store) the metadata and/or the minimum text of the protection message included in the message data in the storage.

In step S22-4, the receiving terminal 12 may display the protection message based on the message data. The receiving terminal 12 may display the protection message in a state that the text of the protection message is protected (non-exposed), and the protection (non-exposure) processing method may be any method (e.g., the processing method may vary depending on the protection policy setting information).

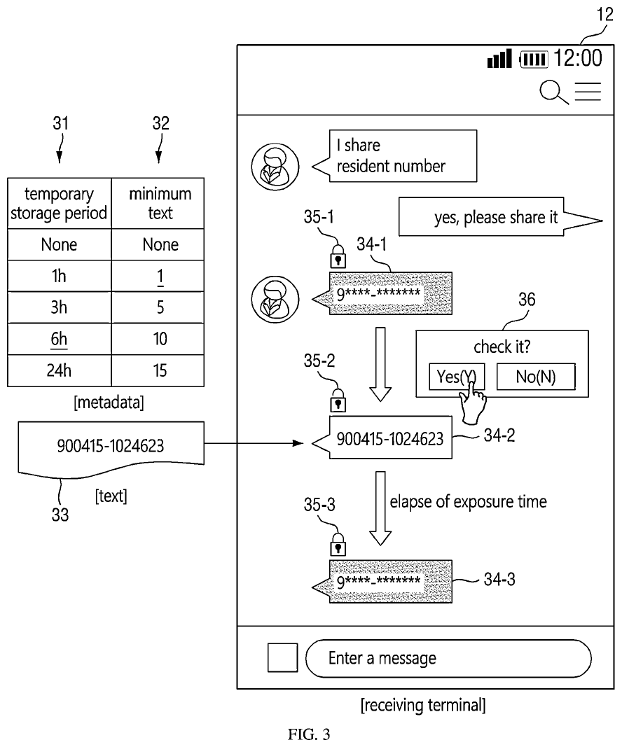

As a detailed example, when the message data consists of only metadata, the receiving terminal 12 may indicate that the protection message is received (i.e., the existence of the protection message is displayed). In this case, the receiving terminal 12 may display the text of the protection message by appropriately using a blank, dummy text and the like, or may indicate the existence of the protection message in a manner that may be visually recognized by the recipient (e.g., an indicator (e.g., 35-1 of FIG. 3) is displayed to be adjacent to a speech bubble of the protection message or the speech bubble of the protection message is displayed in a color different from that of the general message).

As another example, when the message data further includes the minimum text, the receiving terminal 12 may display the protection message so that only the minimum text is exposed to the outside. For example, as shown in FIG. 3, the receiving terminal 12 may display a protection message 34-1 so that only a minimum text (e.g., see ‘9’) of the protection message 34-1 is exposed to the outside. In FIG. 3, it is assumed that a minimum text item 32 is set to ‘one (1) letter’ in protection policies (see 31 and 32) of the protection message 34-1 (see underline).

In step S23, the receiving terminal 12 may receive a text request (i.e., a protection message open request) from the recipient (i.e., user). A method of receiving a text request may be designed and implemented in any way. For example, the receiving terminal 12 may receive a text request (i.e., a user input for requesting a text) through a pop-up interface 36 as shown in FIG. 3, and may recognize the text request of the recipient based on a predefined user input (e.g., mobile gesture such as tap, double tap, swipe and press for the indicator (e.g., 35-1) of the protection message (e.g., 34-1) or the speech bubble (e.g., 34-1) of the protection message).

In steps S24-1 and S24-2, the receiving terminal 12 may transmit a text request (i.e., request message) for the protection message to the transmitting terminal 11. As shown, the message server 10 may receive the text request and forward the same to the transmitting terminal 11 (S24-2).

As the text request is received, the transmitting terminal 11 may provide a notification (e.g., push notification) to the sender or may not. Also, as the text request is received, the transmitting terminal 11 may provide an interface for setting a protection policy of the corresponding protection message or may not.

In step S25, a reset (e.g., change) for the protection policy may be performed. For example, the sender may change a temporary storage period of the protection message, etc., as necessary. When the protection policy is reset (e.g., changed), the metadata (i.e., metadata including reset information) of the protection message may be again transmitted to the message server 10 and the receiving terminal 12 (e.g., transmitted together with the text in step S26-1).

In step S26-1, the transmitting terminal 11 may transmit a text (e.g., the entire text, the rest excluding the minimum text, etc.) of the protection message to the receiving terminal 12 in response to the text request. As shown, the text of the protection message may be transmitted to the receiving terminal 12 through the message server 10. However, a detailed method in which text transmission is triggered by the transmitting terminal 11 may vary depending on embodiments.

In some embodiments, the transmitting terminal 11 may automatically (i.e., without intervention of the sender) transmit the text of the protection message in response to the text request.

In some other embodiments, the transmitting terminal 11 may transmit the text of the protection message in response to the user input of the sender. For example, the transmitting terminal 11 may provide a notification (e.g., pop-up interface, etc.) about the reception of the text request to the sender. In addition, the transmitting terminal 11 may transmit the text of the protection message based on the user input of the sender who approves the transmission of the text. The method of receiving the user input may be any method (e.g., receiving the user input through the pop-up interface (e.g., 36 of FIG. 3), recognizing the user input through a mobile gesture such as tap, double tap, swipe and press for the protection message speech bubble (e.g., 34-1) or the indicator (e.g., 35-1) of the protection message (e.g., 34-1), etc.).

In step S26-2, the message server 10 may temporarily store the received text in the storage (S26-2). In this case, the text may be stored for the temporary storage period set in the protection policy. That is, the message server 10 may delete (dispose) the text from the storage as the temporary storage period set in the corresponding protection message elapses. For example, referring back to FIG. 3, in case of the protection message 34-1, since the temporary storage period item 31 is set to ‘6 hours’ in the protection policies (see 31 and 32), when ‘6 hours’ elapses, the text 33 of the protection message 34-1 may be deleted from the storage of the message server 10. As a result, the message protection function may be further enhanced.

In step S26-3, the message server 10 may forward (transmit) the received text to the receiving terminal 12.

Meanwhile, in some cases, a plurality of receiving terminals 12 may exist. For example, there may be a case that the recipient logs in to multiple terminals with his or her account (i.e., the same account) and uses a message service, or there may be a case that multiple recipients exist in a chat room to which the sender belongs. In this case, the message server 10 may transmit the text only to the receiving terminal 12 requesting the text among the plurality of receiving terminals.

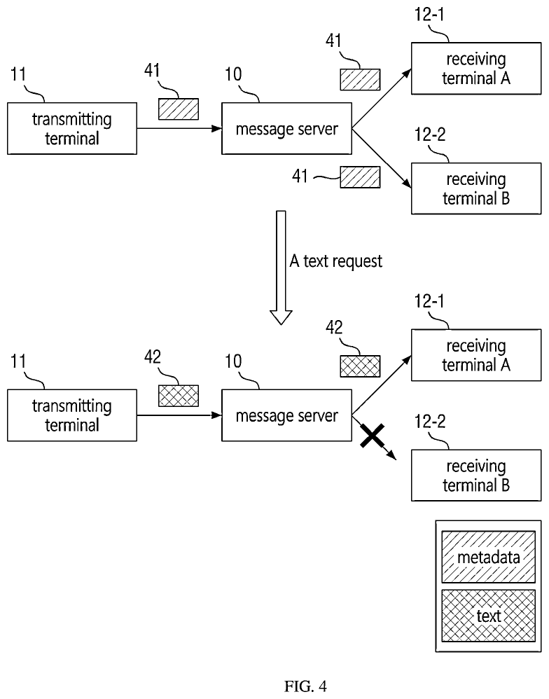

For example, as shown in FIG. 4, it is assumed that the message server 10 transmits metadata 41 of the protection message to two receiving terminals 12-1 and 12-2. In FIG. 4, it is assumed that message data for transmitting the protection message consists of only the metadata 41. Also, it is assumed that only one 12-1 of the two receiving terminals 12-1 and 12-2 requests the message server 10 of the text (that is, the message server 10 does not receive the text request from the other receiving terminal 12-2). In this case, the message server 10 may transmit the text 42 received from the transmitting terminal 11 only to the text requesting terminal 12-1. Therefore, the possibility that the text of the protection message is exposed to the outside may be further reduced, and the message protection function may be further enhanced.

The description will be given with reference to FIG. 2 again.

In step S27, the receiving terminal 12 may display the text of the protection message. That is, the receiving terminal 12 may display (process) the text of the protection message so that the text of the protection message is exposed to the recipient. For example, as shown in FIG. 3, the received text 33 may be displayed to be exposed to the recipient (see 34-2) (e.g. in this case, a shape of the indicator 35-1, a color of the speech bubble, etc., which indicate the protection message 34-1, may be also changed (see 35-2 and 34-2)).

In some cases, the receiving terminal 12 may also temporarily store the text of the protection message. For example, the receiving terminal 12 may also temporarily store the text of the protection message in accordance with the protection policy (i.e., the temporary storage period item) set in the protection message.

In some embodiments, as shown in FIG. 3, as a predetermined exposure time elapses, the receiving terminal 12 may automatically perform the non-exposure process for the text 33 of the protection message 34-1 (see 34-3) (e.g., in this case, the shape of the indicator 35-1, the color of the speech bubble, etc., which indicate the protection message 34-1, may be also changed (see 35-3 and 34-3)). As a result, the problem of exposing the text of the protection message due to the carelessness of the recipient may be greatly alleviated, and the message protection function may be further enhanced. As described above, the exposure time may be set through the protection policy and may be set for each terminal by the recipient. Afterwards, the recipient may again confirm the text 33 of the non-exposed protection message 34-3 (e.g., when a predefined user input is received, the text 33 may be exposed again), and when the predetermined exposure time elapses based on the exposure time of the text 33, the non-exposure processing may be applied to the text 33 again.

The description will be given with reference to FIG. 2 again.

In step S28, when the recipient confirms the text of the protection message through the terminal 12, the receiving terminal 12 may transmit a text reading notification (i.e., a notification message) to the message server 10. A method of determining whether the recipient reads (confirms) the text by the receiving terminal 12 may be any method.

In step S29, the message server 10 may delete the text of the protection message from the storage in response to the reception of the text reading notification. For example, the message server 10 may delete the corresponding text from the storage regardless of the temporary storage period set in the protection policy of the protection message (i.e., delete the text even though the temporary storage period has not elapsed). As a result, the message protection function may be further enhanced.

Meanwhile, there may be a case that the receiving terminal 12 again requests the text for the protection message for various reasons. That is, there may be a case that the message server 10 re-receives the text request for the same protection message from the receiving terminal 12. In this case, when there is a text temporarily stored in the storage, the message server 10 may transmit the corresponding text to the receiving terminal 12. When there is no text temporarily stored in the storage, the message server 10 may re-acquire the text of the corresponding protection message through the transmitting terminal 11 and transmit the same to the receiving terminal 12.

Meanwhile, according to some embodiments of the present disclosure, at least some items of the protection policy may be automatically set or adjusted based on various factors. Such an operation may be performed by any one of the transmitting terminals 11, the receiving terminal 12 and the message server 10. Hereinafter, the description will be continued on the assumption that the corresponding operation is performed by the ‘message server 10’.

For example, a length of the minimum text (i.e., the minimum text item) may be automatically set or adjusted. In detail, the message server 10 may automatically set or adjust the length of the minimum text based on location information of the terminals (e.g., 11 and 12), the sensitivity of information included in the text, the length of the text, the analysis result of the text, the exposure time (i.e., setting value of the exposure time item), the temporary storage period (i.e., the setting value of the temporary storage period item), the number of entities of the text and the number of entity categories (e.g., people, places, etc.). For example, the message server 10 may decrease the length of the minimum text when the terminals (e.g., 11 and 12) are located in a dense area such as a public place, and may increase the length of the minimum text in an opposite case. Alternatively, the message server 10 may set or adjust the length of the minimum text to a smaller value as the information sensitivity is higher, the length of the text is shorter, the analysis intensity is higher, the exposure time is set to a shorter value, the temporary storage period is set to shorter period, the number of entities is smaller and/or the number of entity categories is smaller.

As another example, the exposure time (i.e., the exposure time item) may be automatically set or adjusted. In detail, the message server 10 may automatically set or adjust the exposure time based on location information of the terminals (e.g., 11 and 12), the sensitivity of information included in the text (or the minimum text), the analysis result of the text (or the minimum text), the length of the text (or the minimum text), the temporary storage period (i.e., the setting value of the temporary storage period item), the number of entities in the text (or the minimum text), the number of entity categories (e.g., people, places, etc.). For example, the message server 10 may decrease the exposure time when the terminals (e.g., 11 and 12) are located in a dense area such as a public place, and may increase the exposure time in an opposite case. Alternatively, the message server 10 may set or adjust the exposure time to a smaller value as the information sensitivity of the text is higher, the analysis intensity is higher, the length of the text is longer, the temporary storage period is set to a shorter period, the number of entities is larger and/or the number of entity categories is larger.

As other example, the temporary storage period (i.e., the temporary storage period item) may be automatically set or adjusted. In detail, the message server 10 may automatically set or adjust the temporary storage period based on the sensitivity of information included in the text, the analysis result of the text, the length of the text, the exposure time (i.e., the setting value of the exposure time item), the number of entities in the text, and the number of entity categories (e.g., people, places, etc.). For example, the message server 10 may set or adjust the temporary storage period to a smaller value as the information sensitivity of the text is higher, the analysis intensity is higher, the length of the text is longer, the exposure time is set to a smaller value, the number of entities is larger and/or the number of entity categories is larger.

The general process of the method for protecting a message according to some embodiments of the present disclosure has been described as above with reference to FIGS. 2 to 4. As described above, the message data for transmitting the corresponding protection message may be configured by excluding at least a portion of the text of the protection message. Therefore, the case that the entire text of the protection message is exposed from the receiving terminal 12 may be avoided in advance. For example, the case that sensitive information of the sender and/or the recipient is exposed to others in a public place may be avoided in advance.

Also, only when the recipient requests the text, the text of the protection message may be transmitted from the transmitting terminal to the receiving terminal 12 and exposed to the recipient. Therefore, the case that sensitive information of the sender and/or the recipient is exposed due to the carelessness of the recipient, or the like may be minimized.

In addition, the text of the protection message may be temporarily stored in the storage of the message server 10 and may be deleted from the storage as a preset temporary storage period elapses. Therefore, the message protection function may be further enhanced.

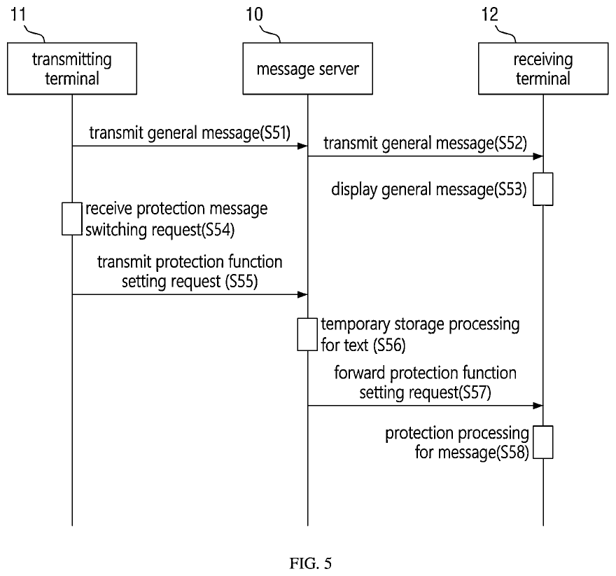

Hereinafter, the process of the method for protecting a message regarding cases different from those shown in FIG. 2 will be described with reference to the drawings subsequent to FIG. 5.

FIG. 5 is an exemplary flow chart illustrating a process of switching a general message to a protection message in accordance with some embodiments of the present disclosure (i.e., a process of changing a message type from a general message to a protection message). However, this is only a preferred embodiment for achieving the object of the present disclosure, and some steps may be added or deleted as needed.

As shown in FIG. 5, the present process relates to the case of switching the general message to the protection message at the request of the sender (i.e., the case of setting the protection function later).

First, it is assumed that the transmitting terminal 11 transmits the general message to the receiving terminal 12 (S51 to S53). As described above, the general message means a normal message in which the text is exposed from the receiving terminal 12 as it is. In this case, the sender may set the protection function to the general message later, and as a result, the general message may be switched to the protection message (that is, the type of the corresponding message is changed from the general message to the protection message).

In detail, in step S54, the transmitting terminal 11 may receive a protection message switching request for the corresponding general message. A method of receiving (inputting) the switching request may be designed and implemented in any way. For example, the transmitting terminal 11 may receive the switching request in the same or similar manner as or to the above-described step S21. As a more detailed example, the transmitting terminal 11 may receive the user input requesting to switch the general message to the protection message. In addition, the transmitting terminal 11 may receive the protection policy setting information from the sender. Hereinafter, for clarity of the present disclosure, the message in which the switching request is received will be referred to as a ‘target message’.

In step S55, the transmitting terminal 11 may transmit a protection function setting request to the message server 10. In this case, the protection function setting request may include metadata (or protection policy setting information) for the target message.

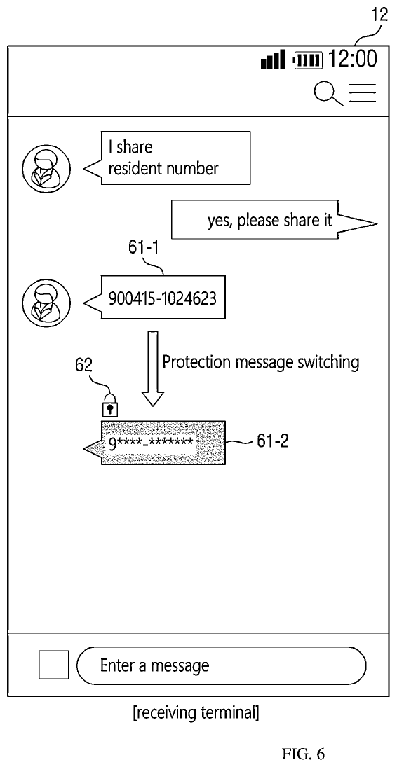

In steps S56 to S58, protection processing may be performed for the target message. For example, the message server 10 may process the text of the target message to be temporarily stored in the storage (S56) and forward the protection function setting request to the receiving terminal 12 (S57). Then, the receiving terminal 12 may perform non-exposure (protection) processing for the text of the target message (S58) (e.g., the minimum text may be exposed in accordance with the protection policy). For example, as shown in FIG. 6, the receiving terminal 12 may perform non-exposure processing for the target message 61-1 (see 61-2 and 62). In some cases, in response to the protection function setting request, the receiving terminal 12 may delete the text of the target message from the storage therein or temporarily store the same. These steps will be understood with further reference to the description of the above-described steps S26-2 to S29.

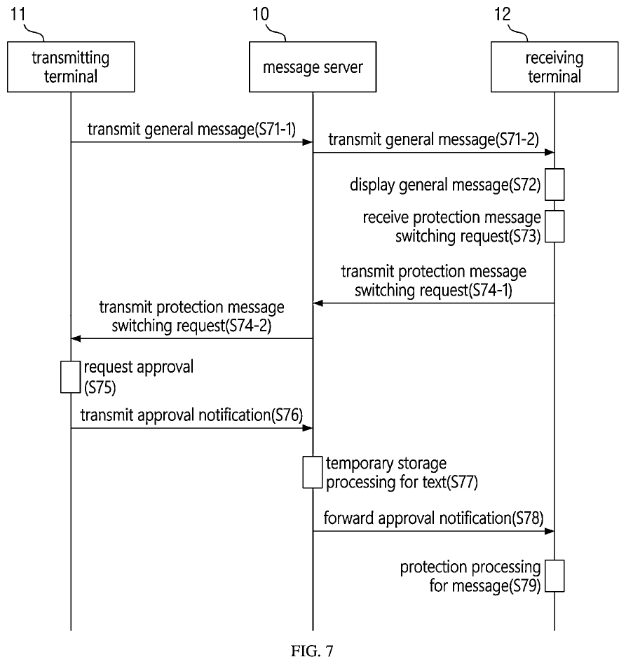

Hereinafter, a process of switching a general message to a protection message in accordance with some other embodiments of the present disclosure will be described with reference to FIG. 7. However, for clarity of the present disclosure, the description repeated with the previous embodiments will be omitted.

FIG. 7 is an exemplary flow chart illustrating a process of switching to a protection message in accordance with some other embodiments of the present disclosure. However, this is only a preferred embodiment for achieving the object of the present disclosure, and some steps may be added or deleted as needed.

As shown in FIG. 7, the present embodiments relate to the case of switching the general message to the protection message at the request of the recipient (i.e., the case of setting the message protection function later).

First, it is assumed that the receiving terminal 12 receives the general message (i.e., target message) from the transmitting terminal 11 (S71-1, S71-2 and S72). In this case, the recipient may request to set the protection function in the target message later, and the target message may be switched to the protection message based on an approval (permission) of the sender (that is, the type of the target message is changed from the general message to the protection message).

In detail, in step S73, the receiving terminal 12 may receive a protection message switching request for the target message from the recipient (i.e., user). A method of receiving (inputting) the switching request may be designed and implemented in any way.

In step S73, the receiving terminal 12 may receive protection policy setting information for the target message from the recipient, or may not. When the protection poly setting information is input, the input information may be included in the protection message switching request and then transmitted to the transmitting terminal 11.

In steps S74-1 and S74-2, the protection message switching request may be forwarded to the transmitting terminal 11 through the message server 10.

As the protection message switching request is received, the transmitting terminal 11 may provide a notification (e.g., push notification) to the sender. In addition, the transmitting terminal 11 may further provide an interface for approving or rejecting the protection message switching request. In some cases, the transmitting terminal 11 may further provide an interface for setting (or changing) the protection policy to the sender.

Meanwhile, FIG. 7 illustrates a case that the sender approves the protection message switching request as an example, but the scope of the present disclosure is not limited thereto, and the sender may reject the protection message switching request.

In step S75, the transmitting terminal 11 may receive a user input for approving the protection message switching request from the sender. The method of receiving such a user input may be designed and implemented in any way. In some cases, the sender may make an approval by changing at least portion of the protection policy set in the target message or may directly set (input) the protection policy through a protection policy setting interface.

In step S76, the transmitting terminal 11 may transmit an approval notification for the protection message switching request to the message server 10. The approval notification may include metadata (or protection policy setting information) for the target message. The approval notification may be understood as a message (signal) for performing a function substantially the same as or similar to the protection function setting request shown in FIG. 5.

In steps S77 to S79, protection processing may be performed for the target message. This will be understood with reference to the above-described description of the steps S56 to S58.

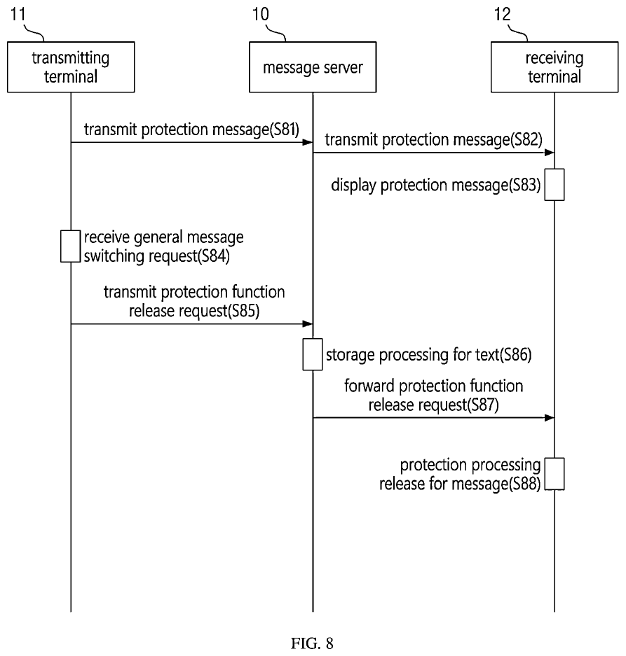

Hereinafter, a process of switching a protection message to a general message in accordance with some embodiments of the present disclosure will be described with reference to FIG. 8.

FIG. 8 is an exemplary flow chart illustrating a process of switching to a general message in accordance with some embodiments of the present disclosure. However, this is only a preferred embodiment for achieving the object of the present disclosure, and some steps may be added or deleted as needed.

As shown in FIG. 8, this process relates to the case of switching the protection message to the general message at the request of the sender (i.e., the case of releasing the protection function later).

First, it is assumed that the transmitting terminal 11 transmits the protection message (i.e., target message) to the receiving terminal 12 (S81 to S83). In this case, the sender may release the protection function set in the target message later, and as a result, the target message may be switched to the general message (that is, the type of the target message is switched from the protection message to the general message).

In detail, in step S84, the transmitting terminal 11 may receive a general message switching request for the target message. A method of receiving (inputting) the switching request may be designed and implemented in any way.

In step S85, the transmitting terminal 11 may transmit a protection function release request to the message server 10. In this case, the protection function release request may include the text of the target message, and may further include metadata in some cases.

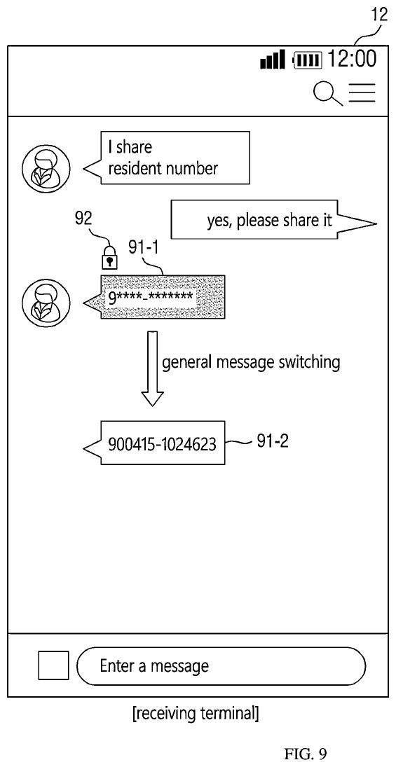

In steps S86 to S88, the protection processing for the target message may be released. For example, the message server 10 may store and process the text of the target message (S86) (that is, the text is stored and managed in the storage regardless of the temporary storage period of the protection policy), and may forward the protection function release request to the receiving terminal 12. Then, the receiving terminal 12 may release the protection processing for the text of the target message (S88) (that is, the text is displayed (processed) so that the text is exposed as it is). For example, as shown in FIG. 9, the receiving terminal 12 may display (process) a text of a target message 91-1 so that the text of the target message 91-1 is exposed as it is (refer to 91-2 and 92). Also, the receiving terminal 12 may store the text of the target message in the storage therein.

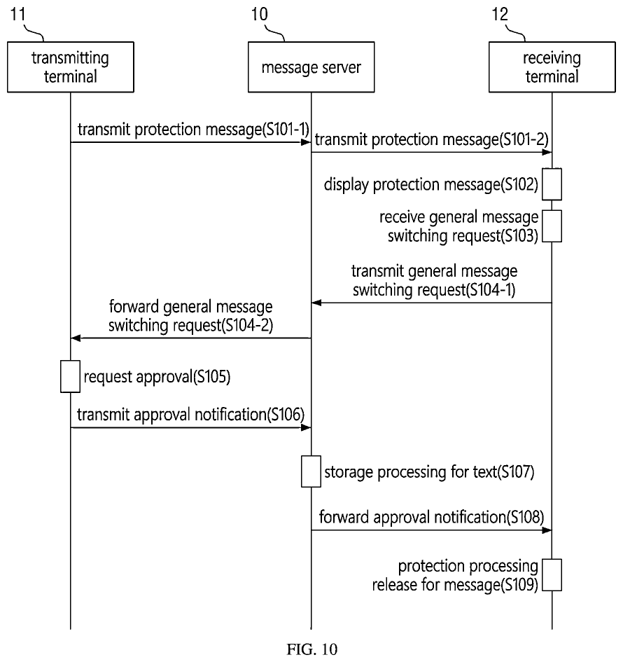

Hereinafter, a process of switching the protection message to the general message in accordance with some other embodiments of the present disclosure will be described with reference to FIG. 10. However, for clarity of the present disclosure, the description repeated with the previous embodiments will be omitted.

FIG. 10 is an exemplary flow chart illustrating a process of switching to a general message in accordance with some other embodiments of the present disclosure. However, this is only a preferred embodiment for achieving the object of the present disclosure, and some steps may be added or deleted as needed.

As shown in FIG. 10, the present embodiments relate to the case of switching the protection message to the general message at the request of the recipient (i.e., the case of releasing the message protection function later).

First, it is assumed that the receiving terminal 12 receives the general message (i.e., target message) from the transmitting terminal 11 (S101-1, S101-2 and S102). In this case, the recipient may request to release the protection function of the target message later, and the target message may be switched to the general message based on approval (permission) of the sender (that is, the type of the target message is changed from the protection message to the general message).

In detail, in step S103, the receiving terminal 12 may receive a general message switching request for the target message from the recipient (i.e., user). A method of receiving (inputting) the switching request may be designed and implemented in any way.

In steps S104-1 and S104-2, the general message switching request may be forwarded to the transmitting terminal 11 through the message server 10.

As the general message switching request is received, the transmitting terminal 11 may provide a notification (e.g., push notification) to the sender. In addition, the transmitting terminal 11 may further provide an interface for approving or rejecting the general message switching request. In some cases, the transmitting terminal 11 may further provide an interface for setting (or changing) the protection policy to the sender (e.g., the case that the request is rejected but the protection policy is to be alleviated).

Meanwhile, FIG. 10 illustrates a case that the sender approves the general message switching request as an example, but the scope of the present disclosure is not limited thereto, and the sender may reject the general message switching request.

In step S105, the transmitting terminal 11 may receive a user input for approving the general message switching request from the sender. The method of receiving such a user input may be designed and implemented in any way. In some cases, the sender may make reject the switching request and change at least portion of the protection policy set in the target message (e.g., the temporary storage period, the exposure time, etc. are set to be longer than the existing case).

In step S106-1, the transmitting terminal 11 may transmit an approval notification for the general message switching request to the message server 10. The approval notification may include the text of the target message and may further include metadata in some cases. The approval notification may be understood as a message (signal) for performing a function substantially the same as or similar to the protection function release request shown in FIG. 8.

In steps S107 to S109, protection processing may be performed for the target message. This will be described with reference to the above-described description of the steps S86 to S88.

The process of the method for protecting a message regarding the cases different from those shown in FIG. 2 has been described with reference to FIGS. 5 to 10. As described above, the switching function between the general message and the protection message may be provided in accordance with the request of the sender or the recipient, so that a flexible message protection function may be implemented.

Hereinafter, an exemplary computing device 110 capable of implementing the transmitting terminal 11, the receiving terminal 12 and/or the message server 10 in accordance with some embodiments of the present disclosure will be described with reference to FIG. 11.

FIG. 11 is an exemplary hardware schematic view illustrating a computing device 110.

As shown in FIG. 11, the computing device 110 may include one or more processors 111, a bus 113, a communication interface 114, a memory 112 for loading a computer program performed by the processor 111, and a storage 115 for storing the computer program 116. However, only components related to the embodiment of the present disclosure are shown in FIG. 11. Therefore, those skilled in the art to which the present disclosure pertains may note that other general-purpose components may be further included in the computing device 110 in addition to the components shown in FIG. 11. That is, the computing device 110 may further include various components in addition to the components shown in FIG. 11. Also, in some cases, the computing device 110 may be configured in a form in which some of the components shown in FIG. 11 are omitted. Hereinafter, each component of the computing device 110 will be described.

The processor 111 may control the overall operation of each component of the computing device 110. The processor 111 may include at least one of a Central Processing Unit (CPU), a Micro Processor Unit (MPU), a Micro Controller Unit (MCU), a Graphic Processing Unit (GPU), or any type of processor well known in the technical field of the present disclosure. In addition, the processor 111 may perform computation for at least one application or program for executing the method/operation according to the embodiments of the present disclosure. The computing device 110 may include one or more processors.

Next, the memory 112 may store various data, commands and/or information. The memory 112 may load the computer program 116 from the storage 115 to execute the method/operation according to the embodiments of the present disclosure. The memory 112 may be implemented as a volatile memory such as RAM, but the technical scope of the present disclosure is not limited thereto.

Next, the bus 113 may provide a communication function between the components of the computing device 110. The bus 113 may be implemented as various types of buses such as an address bus, a data bus and a control bus.

Next, the communication interface 114 may support wired/wireless Internet communication of the computing device 110. Also, the communication interface 114 may support various communication methods other than Internet communication. To this end, the communication interface 114 may include a communication module well known in the technical field of the present disclosure.

Next, the storage 115 may non-temporarily store one or more computer programs 116. The storage 115 may include a non-volatile memory such as a Read Only Memory (ROM), an Erasable Programmable ROM (EPROM), an Electrically Erasable Programmable ROM (EEPROM) and a flash memory, a hard disk, a detachable disk or any type of computer-readable recording medium well known in the art to which the present disclosure pertains.

Next, the computer program 116 may include one or more instructions that, when loaded into the memory 112, cause the processor 111 to perform the method/operation according to various embodiments of the present disclosure. That is, the processor 111 may perform the method/operation according to various embodiments of the present disclosure by executing the one or more instructions.

For example, the computer program 116 may include instructions to perform an operation of acquiring a protection message, an operation of configuring message data for transmission by excluding at least a portion of a text of the protection message, an operation of transmitting the message data to a receiving terminal 12 of the protection message, receiving a text request for the protection message from the receiving terminal 12, and an operation of transmitting the text of the protection message to the receiving terminal 12 in response to the text request. Alternatively, the computer program 116 may include instructions to perform at least a portion of the operations of the transmitting terminal 11, which are described with reference to FIGS. 1 to 10. In this case, the transmitting terminal 11 according to some embodiments of the present disclosure may be implemented through the computing device 110.

For another example, the computer program 116 may include instructions to perform an operation of receiving message data, which does not include at least a portion of a text of a protection message from a transmitting terminal 11, an operation of receiving a user input for requesting the text of the protection message from a user of the receiving terminal 12, an operation of transmitting a text request for the protection message to the transmitting terminal in response to the user input, and an operation of receiving the text of the protection message from the transmitting terminal 11 and processing the received text to be exposed to the user. Alternatively, the computer program 116 may include instructions to perform at least a portion of the operations of the receiving terminal 12, which are described with reference to FIGS. 1 to 10. In this case, the receiving terminal 12 according to some embodiments of the present disclosure may be implemented through the computing device 110.

For other example, the computer program 116 may include instructions to perform an operation of receiving message data, which does not include at least a portion of a text of a protection message from a transmitting terminal 11, an operation of transmitting the message data to a receiving terminal 12 of the protection message, an operation of receiving a text request for the protection message from the receiving terminal 12 and forwarding the text request to the transmitting terminal 11, and an operation of receiving the text of the protection message from the transmitting terminal 11 and forwarding the text to the receiving terminal. Alternatively, the computer program 116 may include instructions to perform at least a portion of the operations of the message server 10, which are described with reference to FIGS. 1 to 10. In this case, the message server 10 according to some embodiments of the present disclosure may be implemented through the computing device 110.

Meanwhile, in some embodiments, the computing device 110 shown in FIG. 11 may mean a virtual machine implemented based on the cloud technology. For example, the computing device 110 may be a virtual machine operating on one or more physical servers included in a server farm. In this case, at least some of the processor 111, the memory 112 and the storage 115, which are shown in FIG. 11, may be virtual hardware, and the communication interface 114 may be also implemented with a virtualized networking element such as a virtual switch.

The exemplary computing device 110 capable of implementing the transmitting terminal 11, the receiving terminal 12 and the message server 10 in accordance with some embodiments of the present disclosure has been described with reference to FIG. 11.

So far, a variety of embodiments of the present disclosure and the effects according to embodiments thereof have been mentioned with reference to FIGS. 1 to 11. The effects according to the technical idea of the present disclosure are not limited to the forementioned effects, and other unmentioned effects may be clearly understood by those skilled in the art from the description of the specification.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications can be made to the preferred embodiments without substantially departing from the principles of the present disclosure. Therefore, the disclosed preferred embodiments of the disclosure are used in a generic and descriptive sense only and not for purposes of limitation.

What is claimed is:

1. A method for protecting a message, performed by a transmitting terminal, the method comprising:
acquiring a protection message;
configuring message data for transmission by excluding at least a portion of a text of the protection message;
transmitting the message data to a receiving terminal of the protection message;
receiving a text request for the protection message from the receiving terminal; and
transmitting the text of the protection message to the receiving terminal in response to the text request.

2. The method of claim 1, wherein the protection message is a message in which a protection function is set by a user of the transmitting terminal and wherein the configuring message data includes configuring the message data only with metadata except for the text of the protection message.

3. The method of claim 1, wherein policy setting information on the protection message includes setting information on a minimum text exposed to a user of the receiving terminal, and
the configuring message data includes configuring the message data to include a portion of the text of the protection message, which is set as a minimum text.

4. The method of claim 1, further comprising:
receiving a switching request for the protection message from a user of the transmitting terminal, the switching request being a request to switch the protection message to a general message; and
transmitting a protection function release request including the text of the protection message to the receiving terminal in response to the switching request, wherein the receiving terminal receiving the protection function release request processes the text to be exposed to a user of the receiving terminal.

5. The method of claim 1, further comprising:
receiving a switching request for the protection message from the receiving terminal, the switching request being a request to switch the protection message to a general message;
receiving a user input for approving the switching request from a user of the transmitting terminal; and
transmitting an approval notification including the text of the protection message to the receiving terminal in response to the user input,
wherein the receiving terminal receiving the approval notification processes the text to be exposed to a user of the receiving terminal.

6. The method of claim 1, further comprising:
transmitting a message to the receiving terminal, the message being a general message in which a text is exposed to a user of the receiving terminal;
receiving a switching request for the message from a user of the transmitting terminal, the switching request being a request to switch the message to the protection message; and
transmitting a protection function setting request for the message to the receiving terminal in response to the switching request,
wherein the receiving terminal receiving the protection function setting request processes at least a portion of the text of the message to be non-exposed.

7. The method of claim 1, further comprising:
transmitting a message to the receiving terminal, the message being a general message in which a text is exposed to a user of the receiving terminal;
receiving a switching request for the message from the receiving terminal, the switching request being a request to switch the message to the protection message;
receiving a user input for approving the switching request from a user of the transmitting terminal; and
transmitting an approval notification for the switching request to the receiving terminal in response to the user input,
wherein the receiving terminal receiving the approval notification processes at least a portion of the text of the message to be non-exposed.

8. A method for protecting a message, performed by a message server, the method comprising:
receiving message data for a protection message from a transmitting terminal, the message data for not including at least a portion of a text of the protection message;
transmitting the message data to a receiving terminal of the protection message;
receiving a text request for the protection message from the receiving terminal and forwarding the text request to the transmitting terminal; and
receiving the text of the protection message from the transmitting terminal and forwarding the text to the receiving terminal.

9. The method of claim 8, wherein the text of the protection message is temporarily stored in a storage of the message server and is deleted from the storage as a temporary storage period set in the protection message elapses.

10. The method of claim 9, further comprising:
re-receiving the text request for the protection message from the receiving terminal;
when there is a text temporarily stored in the storage. transmitting the temporarily stored text to the receiving terminal; and
re-acquiring the text of the protection message through the transmitting terminal and transmitting the text to the receiving terminal when there is no text temporarily stored in the storage.

11. The method of claim 8, further comprising:
temporarily storing the text of the protection message in a storage; and
deleting the temporarily stored text regardless of a temporary storage period set in the protection message when receiving a reading notification for the text of the protection message from the receiving terminal.

12. The method of claim 8, wherein the message data is further transmitted to another receiving terminal other than the receiving terminal,
the forwarding the text request includes forwarding the text to only the receiving terminal when the text request for the protection message is not received from another receiving terminal.

13. A method for protecting a message, performed by a receiving terminal, the method comprising:
receiving message data for a protection message from a transmitting terminal, the message data for not including at least a portion of a text of the protection message;
receiving a user input for requesting the text of the protection message from a user of the receiving terminal;
transmitting a text request for the protection message to the transmitting terminal in response to the user input; and
receiving the text of the protection message from the transmitting terminal and processing the received text to be exposed to the user.

14. The method of claim 13, wherein the received text is processed to be non-exposed as a preset time elapses.

15. A transmitting terminal comprising:
one or more processors;
a communication interface; and
a memory storing a computer program executed by one or more processors, wherein the computer program includes instructions to perform:
an operation of acquiring a protection message;
an operation of configuring message data for transmission by excluding at least a portion of a text of the protection message;
an operation of transmitting the message data to a receiving terminal of the protection message;
an operation of receiving a text request for the protection message from the receiving terminal; and
an operation of transmitting the text of the protection message to the receiving terminal in response to the text request.

16. The transmitting terminal of claim 16, further comprising instructions to perform:
an operation of receiving a switching request for the protection message from a user of the transmitting terminal, the switching request being a request to switch the protection message to a general message; and
an operation of transmitting a protection function release request including the text of the protection message to the receiving terminal in response to the switching request,
wherein the receiving terminal receiving the protection function release request processes the text to be exposed to a user of the receiving terminal.

17. The transmitting terminal of claim 15, further comprising instructions to perform:
an operation of receiving a switching request for the protection message from the receiving terminal, the switching request being a request to switch the protection message to a general message;
an operation of receiving a user input for approving the switching request from a user of the transmitting terminal; and
an operation of transmitting an approval notification including the text of the protection message to the receiving terminal in response to the user input,
wherein the receiving terminal receiving the approval notification processes the text to be exposed to a user of the receiving terminal.

18. The transmitting terminal of claim 15, further comprising instructions to perform:
an operation of transmitting a message to the receiving terminal, the message being a general message in which a text is exposed to a user of the receiving terminal;
an operation of receiving a switching request for the message from a user of the transmitting terminal, the switching request being a request to switch the message to the protection message; and
an operation of transmitting a protection function setting request for the message to the receiving terminal in response to the switching request,
wherein the receiving terminal receiving the protection function setting request processes at least a portion of the text of the message to be non-exposed.

19. The transmitting terminal of claim 15, further comprising instructions to perform:
an operation of transmitting a message to the receiving terminal, the message being a general message in which a text is exposed to a user of the receiving terminal;
an operation of receiving a switching request for the message from the receiving terminal, the switching request being a request to switch the message to the protection message;
an operation of receiving a user input for approving the switching request from a user of the transmitting terminal; and
an operation of transmitting an approval notification for the switching request to the receiving terminal in response to the user input,
wherein the receiving terminal receiving the approval notification processes at least a portion of the text of the message to be non-exposed.
